(19) United States
(12) Patent Application Publication
(10) Pub. No.: US 2010/0032188 A1
(43) Pub. Date: Feb. 11, 2010

(54) ELECTRIC INSULATOR AND USE THEREOF

(75) Inventors: Patrick Meier, Staufen (CH); Stephen Clifford, Bremgarten (CH); Tommaso Auletta, Vasteras (SE)

Correspondence Address: VENABLE LLP, P.O. BOX 34385, WASHINGTON, DC, 20043-9998, US

(73) Assignee: ABB Research Ltd., Zurich (CH)

(21) Appl. No.: 12/519,788

(22) PCT Filed: Dec. 17, 2007
(86) PCT No.: PCT/EP2007/064036

§ 371 Date: Jun. 18, 2009

(30) Foreign Application Priority Data
Dec. 18, 2006 (EP) 06126385.1

(51) Int. Cl. H01B 17/64

(52) U.S. Cl. 174/140 C; 977/773

(57) ABSTRACT

An electric insulator including an electric insulation and a semiconducting layer forming on an outermost surface of the insulator that faces the environment surrounding the electric insulator. The semiconducting layer includes a polymer matrix. Particles of a material confer a semiconducting character to the layer. The particles are dispersed in the matrix. The particles include nanostructures.

### TECHNICAL FIELD

The present invention relates to an electric insulator, comprising: an electric insulation; a semiconducting layer, forming on the insulator an outermost surface that faces the surrounding environment; wherein said semiconducting layer comprises a polymer matrix; particles of a material that confers a semiconducting character to said layer, said particles being dispersed in said matrix.

It also relates to the use of such a insulator in a moisture-containing environment, in particular an environment that contains particulate matter that will be deposited on an outer surface of said insulator, such as an out-door environment, in which the semiconducting layer is subjected both to humidity and contamination.

Preferably, the device according to the invention is to be used in medium and, possibly, high voltage applications. Medium voltage is referred to as from about 1 kV up to about 40 kV, while high voltage is referred to as from about 40 kV up to about 150 kV, or even more.

### BACKGROUND OF THE INVENTION

Outdoor electrical insulators such as those used for carrying, or suspending, overhead cables or overhead lines that transmit electric power will be subjected to a substantial electric field generated by said cables or lines. They will also be subjected to a certain contamination of dust, pollution and other particles carried by the surrounding environment, which is mostly air. Accordingly, on top of the outer surface of such an insulator, a layer of contamination will be deposited as time goes on. When the surrounding environment presents a certain humidity, such humidity will also be adopted to a certain level by said contamination layer. However, at local sites along the insulator surface, the contamination layer will be less thick and/or less humid, i.e. less able of conducting an electric current.

Due to the strong electric fields that the insulator is subjected to, there will always be a certain level of creeping current in the insulator as well as in the contamination layer on top thereof. However, at those sites where the thickness and/or moisture content of the contamination layer is reduced the conducting ability of said layer will be reduced to a corresponding degree. At such sites unwanted surface discharge phenomena might occur. Such surface discharges will, in the long term, unfortunately result in a degradation of the underlying material of the insulator, and should therefore be avoided.

### PRIOR ART

Prior art, as for exampled disclosed in DE 197 00 387, suggests the use of a semiconducting outermost layer on the insulator for the purpose of suppressing the generation of surface discharges at the surface of the insulator. The insulator body, as well as said semiconducting layer, is formed by a polymer, which is a novel technique as compared to further prior art that uses ceramic, mostly porcelain, insulators. In order to provide the semiconducting layer with its semiconducting property, DE 197 00 387 suggests the use of different filler materials of electrically semiconducting or conducting character dispersed or embedded in said polymer at the outermost layer of the insulator. DE 197 00 387 suggest the use of soot, metal powder, metal fibres, carbon fibres, etc. as a filler in the polymer matrix of the insulator for the generation of said semiconducting layer. The matrix may, for example, be constituted by silicon rubber or EPDM-rubber.

Considerations as to the efficiency, environment friendliness, durability and affection of the matrix material should be done when choosing the most suitable semiconducting or conducting filler.

### THE OBJECT OF THE INVENTION

It is an object of the present invention to present an insulator as initially defined, the semiconducting layer of which is of such design that there is needed a relatively low degree of filler material used for the purpose of conferring the semiconducting ability to said layer. The semiconducting layer or glaze shall be able of transmitting leakage currents that occur in water or water droplets deposited on an outer surface of the semiconducting layer, thereby suppressing the generation of surface discharges at the surface of the insulator.

It is a further object of the invention to present an insulator as initially defined, in which the filler material that is used for the purpose of conferring the semiconducting ability to said layer affects the structure of the surrounding polymer matrix to a minimum degree.

Preferably, the filler material should be able to make use of interstices in the matrix without negatively affecting the structure and function of the matrix material, and still being present to such a degree that it confers the desired semiconducting functionality to the layer in which it is located.

### SUMMARY OF THE INVENTION

The object of the invention is achieved by means of the initially defined insulator characterised in that said particles comprise one or more nanostructures. Mainly, it is the small size of said nanostructures that will enable them to occupy interstices in the matrix both efficiently and non-disturbingly in the matrix structure. Preferably, nanostructures have at least two dimensions, or a diameter, that are (is) <1 μm, preferably <500 nm, more preferably <100 nm. In general, said two dimensions or diameter are/is >0.1 nm. The third dimension, or length, has no specific upper limit, but may be adapted to the specific application conditions, such as the configuration of the surrounding matrix structure and the requested conductibility of the semiconducting layer. The thickness of the semiconducting layer may also be made very small, for example of nanosize, thanks to the use of nanostructures as electrically semiconducting or conducting filler material in said layer.

Nanostructures include so-called one-dimensional nanoelements, essentially in one-dimensional form, that are of nanometer dimensions in their width or diameter, and that are commonly known as nanowhiskers, nanorods, nanowires, nanotubes, etc. They may be produced by methods such as the well known VLS (vapour-liquid-solid) mechanism, preferably in presence of a catalytic material, whereby said structures are permitted to grow from a specific substrate, for example a silicon-based substrate, under predetermined conditions (heat and gas). A characteristic feature of the production of nanostructures is that the control of the formation of the nanostructures is very precise as the technique permits a controlled growth of the nanostructure atomic layer by atomic layer. By changing said conditions, the property of the nanostructures may be altered in the longitudinal growth direction of the structures.

According to one embodiment, a major proportion of said particles are nanostructures, and according to one embodiment, substantially all of said particles are nanostructures.

According to one embodiment, said particles are evenly dispersed in said matrix.

According to one embodiment, said particles define a percolating network.

According to one embodiment, said particles comprise particles of an electrically semiconducting material. By using a semiconducting material as a filler in the polymer matrix of the semiconducting layer, a non-linear, field-dependent conductivity of said layer may be achieved, which might be of advantage in certain applications. When the electric field to which the semiconducting layer is subjected exceeds a threshold value, the conductivity thereof will increase radically. At sites where the thickness and/or moisture content of a contamination layer is reduced, this will result in an increase of the strength of the electric field. The semiconducting layer may be designed with regard to the presumed field strengths and to the concentrations thereof due to the existence of the abovementioned sites, such that a radically improved conductivity thereof is presented for the field strength assumed to otherwise result in surface discharges at said sites. By using semiconducting particles, the conductivity of the semiconducting layer may be kept very low for lower electric fields of less strength, which might be an advantage.

According to one embodiment, said particles comprise particles of an electrically conducting material. It should be understood that, as a further alternative, said particles may comprise a combination of semiconducting and conducting particles.

According to one embodiment, said particles comprise particles of an inorganic material. One advantage of using inorganic material might be a beneficial effect on the thermal conductivity of the layer provided therewith.

According to one embodiment, the inorganic material comprises at least one oxide. According to one embodiment, said oxide is a metal oxide. According to one embodiment, said at least one metal oxide is chosen from the range of oxides based on Nb, Ta, Ti, Zr, Y, W, Zn and Fe.

According to one embodiment, said semiconducting layer comprises an organic filler. An advantage of an organic filler might be that it can be made relatively ductile and compatible with the surrounding polymer matrix. It might also be less dense compared to suitable inorganic oxides. The organic filler may be of conducting material or semiconducting material and may be used alone or as a complement to further conducting or semiconducting filler material in the semiconducting layer, in order to contribute to the semiconducting properties thereof.

According to one embodiment, said organic filler comprises an electrically conducting polymer. Preferably, the conducting polymer is compatible with the insulating material of the insulator, or with a polymer matrix with which it is mixed or in which it is embedded.

According to one embodiment, said organic filler comprises carbon black. According to yet another embodiment, said organic filler comprises a combination of carbon black and an electrically conducting polymer. According to one embodiment, said particles of carbon black are coated with said electrically conducting polymer.

According to one embodiment, said electrically conducting polymer belongs to the group of conducting polymers that are positively charged. Preferably said conducting polymer comprises polyaniline or polypyrrole or a combination thereof.

According to one embodiment, said conducting polymer belongs to the group of conducting polymers that are negatively charged. Preferably said conducting polymer comprises PEDT or PSS, or a combination thereof.

The insulator may be a line or station insulator or the insulator of any outdoor apparatus arranged for the purpose of controlling or suppressing an electric field of a medium or high voltage conductor. The insulator may be a tubular element that encloses a conductor arranged to carry medium or high voltages. Typically, the insulator of the invention forms part of an electrical insulation system used in the production of electrical components such as transformers, embedded poles, bushings, high-voltage insulators for outdoor use, especially for outdoor insulators associated with high-voltage lines, as long-rod, composite and cap-type insulators, sensors, converters and cable end seals as well as for base insulators in the medium-voltage sector, in the production of insulators associated with outdoor power switches, measuring transducers, lead-throughs, and over-voltage protectors, in switchgear construction. Typically, the insulator is used as a suspension means for suspending electric power overhead lines, thereby being in direct contact with such lines and being subjected to a voltage and an electric field generated by said lines.

Further features of the present invention will be disclosed in the appended claims.

It should be understood that the above description of preferred embodiments has been made in order to exemplify the invention, and that alternative solutions will be obvious for a person skilled in the art, however without departing from the scope of the invention as defined in the appended claims supported by the description.

1. An electric insulator, comprising:
an electric insulation, and
a semiconducting layer forming on the insulator an outermost surface that faces an environment surrounding the insulator, wherein said semiconducting layer comprises a polymer matrix, and wherein said semiconducting layer comprises particles of a material that confers a semiconducting character to said layer, said particles being dispersed in said matrix, wherein said particles comprise nanostructures.

2. The electric insulator according to claim 1, wherein a major proportion of said particles are nanostructures.

3. The electric insulator according to claim 1, wherein substantially all of said particles are nanostructures.

4. The electric insulator according to claim 1, wherein said particles are evenly dispersed in said matrix.

5. The electric insulator according to claim 1, wherein said particles define a percolating network.

6. The electric insulator according to claim 1, wherein said particles comprise particles of an electrically semiconducting material.

7. The electric insulator according to claim 1, wherein said particles comprise particles of an electrically conducting material.

8. The electric insulator according to claim 1, wherein said particles comprise particles of an inorganic material.

9. The electric insulator according claim 8, wherein said inorganic material comprises at least one oxide.

10. The electric insulator according claim 9, wherein said oxide is a metal oxide.

11. The electric insulator according to claim 10, wherein said at least one metal oxide is chosen from the range of oxides based on Nb, Ta, Ti, Zr, Y, W, Zn and Fe.

12. The electric insulator according claim 1, wherein said semiconducting layer comprises an organic filler.

13. The electric insulator according to claim 12, wherein said organic filler comprises an electrically conducting polymer.

14. The electric insulator according to claim 12, wherein said organic filler comprises carbon black.

15. The electric insulator according to claim 12, wherein said organic filler comprises a combination of carbon black and an electrically conducting polymer.

16. The electric insulator according to claim 15, wherein said particles of carbon black are coated with said electrically conducting polymer.

17. The electric insulator according claim 13, wherein said electrically conducting polymer belongs to the group of conducting polymers that are positively charged.

18. The electric insulator according to claim 17, wherein said conducting polymer comprises polyaniline or polypyrrole or a combination thereof.

19. The electric insulator according to claim 13, wherein said conducting polymer belongs to the group of conducting polymers that are negatively charged.

20. The electric insulator according to claim 19, wherein said conducting polymer comprises PEDT or PSS, or a combination thereof.

21. The electric insulator according to claim 1, wherein said electric insulation comprises a polymer.

22. A method, comprising:
providing an electric insulator comprising an electric insulation and a semiconducting layer forming on the insulator an outermost surface that faces an environment surrounding the insulator, wherein said semiconducting layer comprises a polymer matrix, and wherein said semiconducting layer comprises particles of a material that confers a semiconducting character to said layer, said particles being dispersed in said matrix, wherein said particles comprise nanostructures;
utilizing the electric insulator in a moisture-containing environment; and
subjecting the electric insulator to an electric field from an electric conductor.

23. The method according to claim 22, wherein said environment contains particulate matter that will be deposited on an outer surface of said electric insulation device.

24. The method according to claim 22, wherein said environment is an out-door environment.

25. The method according to claim 22, further comprising:
utilizing the electric insulator as a suspension means for an electric power overhead line.
